(19) United States
(12) Patent Application Publication
(10) Pub. No.: US 2007/0084979 A1
(43) Pub. Date: Apr. 19, 2007

(54) Camera tripod head

(75) Inventors: Marco Hofner, Munich (DE); Carl Heinz Soucek, Penzberg (DE)

Correspondence Address: WOLF GREENFIELD & SACKS, PC, FEDERAL RESERVE PLAZA, 600 ATLANTIC AVENUE, BOSTON, MA, 02210-2206, US

(73) Assignee: Sachtler GmbH & Co. KG, Eching (DE)

(21) Appl. No.: 11/497,820

(22) Filed: Aug. 2, 2006

(30) Foreign Application Priority Data
Aug. 10, 2005 (DE) 10 2005 037 782.3

(51) Int. Cl. F16M 11/02

(52) U.S. Cl. 248/177.1

(57) ABSTRACT

The invention pertains to a camera tripod head comprising a camera plate (7) to be mounted on a sliding plate (3), with at least one stop (9) being releasable to the effect that the sliding plate (3) can be detached from the tripod head and replaced in the opposite direction. This makes it possible to perform a shift in the center of gravity within a larger scope.

### TECHNICAL FIELD

The present invention relates to the technical field of camera tripods in which, taking the substantial requirements placed on camera guidance into account, care must be taken that the center of gravity of the camera has the correct relationship to the swivel and tilt movement so as to allow a flawless camera guidance throughout various swivel and tilt ranges.

### PRIOR ART

It is known that a camera is detachably attached to a sliding plate on a camera tripod head using a camera mounting plate attached to said camera, with said camera tripod head conventionally including a damping and weight compensation mechanism for the various camera movements. The detachable attachment thereby is formed by fixing means, the attachment of which limits the displacement of the sliding plate in one direction, with said displacement direction running parallel to the optical axis of the camera. The sliding plate is displaceably guided in a dovetail guide at the tripod head between two stops in conjunction with at least one counter-stop which is attached to the tripod head. In this regard, the sliding plate, which is steplessly displaceable, can be locked steplessly throughout the entire displacement range, with the partial displacement length portions starting from the tilt center of the tripod head having different lengths. This is based on the aim to keep the length of the sliding plate as short as possible so as to avoid difficulties in stowing the tripod. On the other hand, the aforementioned fixing means prevents displacement in one portion, preferably the front portion facing the lens of the camera, so that the larger displacement length is provided at the rear section given that the center of gravity of the camera usually has to be shifted backwards due to the heavy lens so as to be brought into the tilt center of the tripod head.

The aforementioned stops are provided to automatically limit the displacement and thus prevent the sliding plate from becoming completely detached from the tripod head and falling together with the camera.

### DESCRIPTION OF THE INVENTION

It is the technical problem of the invention to design a camera tripod head of the aforementioned type while maintaining the particular fixing means such that the larger partial displacement length can be used to a considerable and effective extent in both displacement directions, thus allowing existing camera tripod heads to be easily refitted or retrofitted.

According to the invention, this object is solved in that the sliding plate can be detached from the tripod head without using a tool and can be mounted in an opposite orientation in the direction of the optical axis of a camera to be mounted given that at least one of the displacement-limiting stops is movable as a free stop from a stop position to a release position outside the movement path with the counter-stop and back.

Based on this replacement in an opposite orientation, said movable free stop allows the longer partial displacement length to become operative both in the forward and in the backward direction of the camera in a simple manner and without a need to use a tool. This allows the camera's center of gravity to be optimally shifted with respect to the tilt axis of the tripod head within an optimum wide range while maintaining a short sliding plate and without modifying the particular fixing mechanism of the existing art, i.e. not only for such cameras whose center of gravity is further towards the front but also for those cameras whose centre of gravity is further towards the back when a lighter lens is used but, for example, an electric storage battery is placed in the rear portion of the camera, which shifts the center of gravity backwards.

The free stop is expediently that stop which is arranged at a distance from the fixing means limiting the displacement of the sliding plate. In connection therewith, the fixing means as such or an independent stop located in front thereof forms the limitation in one direction and the free stop forms the limitation in the other direction, with the free stop being displaceable and the sliding plate then being removable on any side. The sliding plate thus forms an interface for adjustments regarding a shoulder pad, an attachment to a body support or other possible applications of the camera irrespective of the actual camera tripod head.

The free stop can be part of a hand-operated lever or part of a hand-operated pressure rod or part of a hand-operated pull rod. If the lever, the pressure rod or the pull rod is spring-loaded, the free stop can be pressed into the stop position by this spring if no actuation occurs. When actuated, the free stop is shifted to the release position against the action of the spring. This ensures in particular a rapid, uncomplicated and efficient detachability of the sliding plate. In connection therewith, the spring force as well as the actuating path can be set so as to make an unintended actuation difficult. In particular, this should be set adequately with respect to the actuating path when using a lever in which the distance between the stop as part of the lever and the lever axis is as large as possible.

This ensures an increased security.

An unintended actuation is made difficult even if a handle for the lever, the pressure rod or the pull rod is mounted on the sliding plate in an accessible but protected manner.

The free stop can expediently be mounted on the sliding plate and the counter-stop on the tripod head, with both stops preferably being mounted on the sliding plate and the counter-stop on the tripod head. The opposite can also be the case.

The free stop is preferably provided with an abutting surface, which can be formed by an inclined plane or a curve. When the sliding plate is inserted in the guidance of the tripod head, the abutting surface abuts against the counter-stop and displaces the lever, the pressure rod or the pull rod against the spring force such that the free stop will move automatically and will be movable to the stop position behind the counter-stop without actuating the lever, the pressure rod or the pull rod. So as to remove the sliding plate, it will be necessary to actuate the lever, the pressure rod or the pull rod to bring the free stop into the release position.

When mention is made in this application of a sliding “plate” and a camera “plate”, this does not have to be exactly a plate. The expression encompasses any plate-like formation, even if it does not comprise flat surfaces throughout. When mention is made of the center of the tripod head, this is that location where the tilt axis and the swivel axis intersect each other. In the first place, this is the location where the tilt axis lies as such.

### BRIEF DESCRIPTION OF THE DRAWINGS

FIG. 1 shows a side view of a camera tripod head with a camera attached thereto;

FIG. 2 shows a bottom view of a sliding plate of the camera tripod head;

FIG. 3a shows a cross-sectional view along the line III-III of FIG. 2 in an extreme displacement position; and

FIG. 3b shows a similar cross-sectional view of the other extreme displacement position of the sliding plate.

### DESCRIPTION OF ONE EXEMPLARY EMBODIMENT OF THE INVENTION

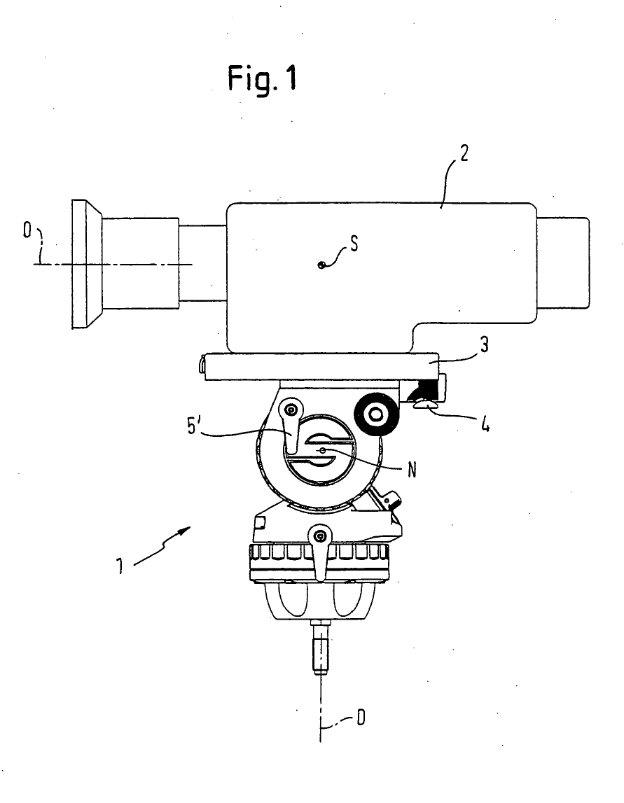

The illustration in FIG. 1 reveals a tripod head 1 with a camera 2 attached thereto. At the bottom side of the camera, there is an unshown camera plate which is inserted in the outer side of a sliding plate 3 and is fixedly secured by fixing means 4. The sliding plate 3 is displaceably guided in the direction of an optical axis O of the camera 2 in the remainder of the tripod head, without the fixing point of the camera in the sliding plate 3 being modified. The respective position of the sliding plate 3 can be locked steplessly using a handle 5 and a mechanism cooperating therewith so as to align the center of gravity S of the camera 2 with a tilt axis N of the tripod head. Furthermore, the camera 2 is rotatable about a rotation axis D and pivotable about the tilt axis N, with the tilt position being steplessly fixable using a handle 5′.

On the upper side of the sliding plate 3 there is a recess 6, in which the camera plate 7 can be inserted and secured by the fixing means 4. The camera can thus be detached from the sliding plate without the alignment of the center of gravity being modified by the displacement of the sliding plate.

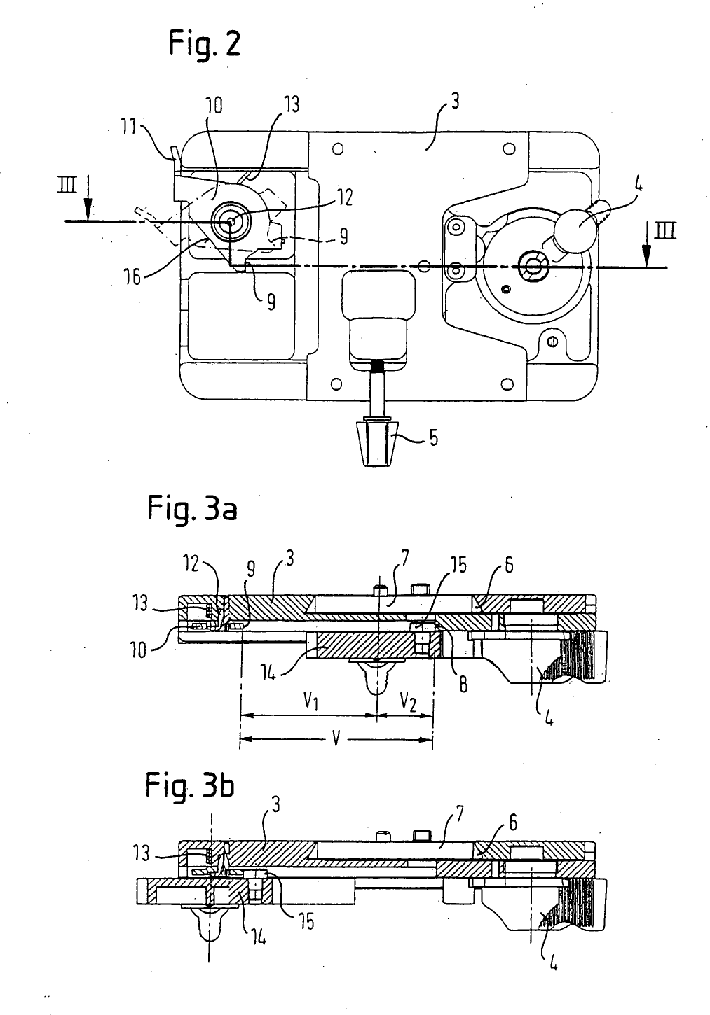

The fixing means 4 necessitates the provision of a stop 8 or a movement limiter for the sliding plate 3 in one direction, in this case to the front, taking the orientation of the camera together with its lens as a reference. A counter-stop 9 is located in the opposite direction, said counter-stop being part of a lever 10 which can be actuated by means of a handle 11. The lever is pivotable about an axis 12, and namely against the action of a spring 13. In the illustration shown by solid lines in FIG. 2, the lever 10 is in the stop position together with the free stop 9 and, in the case of the dotted lines, it is in the free position, with the spring 13 bringing the lever 10 and the free stop 9 back to the stop position when the handle 11 is released.

The sliding plate 3 is displaceable with respect to a fixed member 14, with the total displacement path V as well as the partial displacement paths V₁ and V₂ being represented in FIG. 3a.

Due to the provision of the fixing means 4 and the displacement limitation associated therewith, the partial displacement path V₂ is shorter than the partial displacement path V₁. Both stops abut against a counter-stop 15. The two extreme positions are shown in FIGS. 3a and 3b, with the fixed member 14 however being shown in a displaced manner due to the representation on one sheet.

The expression “free stop” has been used for the stop 9 since it can release the stop position. In the release position illustrated by dotted lines in FIG. 2, the sliding plate 3 can be fully detached, without the counter-stop 15 interfering therewith. When replacing the sliding plate inversely, the long displacement path V₁ will be available in the other direction, i.e. it can be used in both directions when cameras with a greater difference in the position of the center of gravity are to be used on the tripod. So that the handle 11 does not need to be actuated when sliding the sliding plate onto the tripod head, the lever 10 is provided with an inclined abutting surface 16 which is abutted by the counter-stop 15 when the sliding plate 3 is slid onto the tripod head, thus pivoting the lever 10 against the spring force until the lever can spring back together with the free stop 9 once the counter-stop 15 has passed this region.

The force of the spring as well as the path to be traveled by the free stop 9 until it has left the movement path of the counter-stop 15 can be set in such a variable manner as to prevent an unintended release of the free stop 9 as far as possible. This is also achieved as a result of the handle 11 resting as closely as possible against the sliding plate 3 so that it does not offer too large a contact surface.

The system composed of a camera plate and a sliding plate can thus be maintained together with the fixing means, preferably on the side opposite the lens of the camera, while nevertheless allowing the use of the long displacement path V₁ even if a lighter lens is used and storage batteries shifting the center of gravity backwards are possibly placed at the back of the camera.

This allows the existing system to be easily refitted or retrofitted.

1. A camera tripod head comprising a camera plate which is detachably attached to a sliding plate by displacement-limiting fixing means, said sliding plate being displaceably guided at the tripod head, limited between two stops in conjunction with at least one counter-stop, and preferably being steplessly lockable throughout the total displacement ranges, wherein the partial displacement length portions starting from the center of the tripod head have different lengths, characterized in that the sliding plate can be detached from the tripod head without using a tool and can be replaced in an opposite orientation in the direction of the optical axis of a camera to be mounted given that at least one of the displacement-limiting stops is movable as a free stop from a stop position to a release position outside the movement path with the counter-stop and back.

2. The camera tripod head according to claim 1, wherein the free stop is that which is arranged at a distance from the fixing means limiting the displacement of the sliding plate.

3. The camera tripod head according to claim 1, wherein the counter-stop is designed as a free stop and is arranged so as to be laterally displaceable or retractable for this purpose.

4. The camera tripod head according to claim 1, wherein the free stop is part of a hand-operated lever.

5. The camera tripod head acording to claim 1, wherein the free stop is part of a hand-operated pressure rod.

6. The camera tripod head according to claim 1, wherein the free stop is part of a hand-operated pull rod.

7. The camera tripod head according to claim 4, wherein the lever, the pressure rod or the pull rod is spring-loaded such that the free stop is pressed into the stop position.

8. The camera tripod head according to claim 4, wherein the spring force is set so as to make an unintended actuation difficult.

9. The camera tripod head according to claim 4, wherein the actuating path of the free stop is set to have such a large dimension that an unintended actuation is made difficult.

10. The camera tripod head according to claim 4, wherein a handle for the lever, the pressure rod or the pull rod is mounted on the sliding plate in an accessible but protected manner.

11. The camera tripod head according to claim 1, wherein the free stop is mounted on the sliding plate and the counter-stop is mounted on a fixed member of the tripod head.

12. The camera tripod head according to claim 1, wherein both stops are mounted on the sliding plate and a counter-stop is mounted on the fixed member of the tripod head or vice versa.

13. The camera tripod head according to claim 1, wherein the free stop comprises an abutting surface which causes the lever, the pressure rod or the pull rod to give way against the spring force upon abutment of the free stop against the counter-stop when the sliding plate is inserted in the guidance so that the free stop is automatically movable to the stop position behind the counter-stop without being actuated.
